(19) United States
(12) Patent Application Publication
(10) Pub. No.: US 2015/0138358 A1
(43) Pub. Date: May 21, 2015

(54) OBSTACLE MAP GENERATION APPARATUS AND METHOD USING AN ULTRASONIC SENSOR

(71) Applicant: Hyundai Motor Company, Seoul (KR)

(72) Inventors: Hai Jin SEO, Yongin-si (KR); Jong Il YU, Seongnam-si (KR); Won Ho SHIN, Seoul (KR)

(21) Appl. No.: 14/321,556

(22) Filed: Jul. 1, 2014

(30) Foreign Application Priority Data
Nov. 21, 2013 (KR) 10-2013-0142238

(51) Int. Cl. G06K 9/00; G01S 7/52

(52) U.S. Cl. CPC G06K 9/00805; G01S 7/52023
USPC 348/148

(57) ABSTRACT

An obstacle map generation apparatus using an ultrasonic sensor comprises a sensor controller configured to control one ultrasonic sensor of a plurality of ultrasonic sensors to transmit an ultrasonic wave, and control the ultrasonic sensors to receive reflected waves; a signal aligner configured to align the reflected waves received by the ultrasonic sensors; a signal summer configured to sum signals aligned by the signal aligner; an obstacle determiner configured to determine that an obstacle exists if signal strength summed by the signal summer exceeds a threshold; and an obstacle map generator configured to generate an obstacle map based on determining result of the obstacle determiner.

### CROSS-REFERENCE TO RELATED APPLICATION

This application is based on and claims priority from Korean Patent Application No. 10-2013-0142238, filed on Nov. 21, 2013 in the Korean Intellectual Property Office, the disclosure of which is incorporated herein in its entirety by reference.

### BACKGROUND OF THE INVENTION

1. Field of the Invention

The present invention relates to an obstacle map generation apparatus using an ultrasonic sensor and a method thereof, and more particularly, to a technology for generating an obstacle map organically using at least one ultrasonic sensor.

2. Description of the Prior Art

In general, drivers who may be inexperienced at parking a car attempt park the car in a confined space, they may not be able to accurately predict a distance from already parked vehicles on both sides of the space or before and behind the space. Such drivers then move the car forward and reverse several times during the parking.

At this time, if the distance from the neighboring vehicle is wrongly predicted, a minor collision may occur with the already parked vehicles. In some cases, the door of the car cannot be normally opened due to the close distance to a side of an already parked neighboring vehicle. In particular, at night time, since reliability of sight through a side mirror or a rear view mirror is very difficult as compared to daytime, normal parking is more difficult

Smart Parking Assist System (SPAS) has been developed in order to solve this problem. SPAS generates a parking trace based on information collected by using various sensors and places a vehicle to a desired space while tracking the parking trace.

Such SPAS uses a plurality of ultrasonic sensors for detecting an obstacle in a parking trace and at this time, the obstacle detection performance is lowered because each ultrasonic sensor is independently used. That is, if SPAS has a left side ultrasonic sensor, a left rear ultrasonic sensor, a right rear ultrasonic sensor and a right side ultrasonic sensor, because the each ultrasonic sensor is operated to only detect each corresponding position, the detection error rate is high.

### SUMMARY OF THE INVENTION

In order to solve the above-mentioned problems of the prior art, the object of the present invention is to provide an obstacle map generation apparatus using an ultrasonic sensor and a method thereof, capable of decreasing the obstacle detection error and then improving the performance of the obstacle detection by generating an obstacle map organically using at least one ultrasonic sensor.

In order to achieve the above object, an obstacle map generation apparatus using an ultrasonic sensor according to an embodiment of the present invention comprises a sensor controller configured to control one ultrasonic sensor of a plurality of ultrasonic sensors to transmit an ultrasonic wave, and control the ultrasonic sensors to receive reflected waves; a signal aligner configured to align the reflected waves received by the ultrasonic sensors; a signal summer configured to sum signals aligned by the signal aligner; an obstacle determiner configured to determine that an obstacle exists if signal strength summed by the signal summer exceeds a threshold; and an obstacle map generator configured to generate an obstacle map based on determining result of the obstacle determiner.

Also, in order to achieve the above object, another obstacle map generation apparatus using an ultrasonic sensor according to an embodiment of the present invention comprises a sensor controller configured to control one ultrasonic sensor of a plurality of ultrasonic sensors to transmit an ultrasonic wave with a preset time difference, and control the ultrasonic sensors to receive reflected waves; a signal aligner configured to align the reflected waves received by the ultrasonic sensors; a signal summer configured to sum signals aligned by the signal aligner; an obstacle determiner configured to determine that an obstacle exists if signal strength summed by the signal summer exceeds a threshold; and an obstacle map generator configured to generate an obstacle map based on determining result of the obstacle determiner.

Meanwhile, in order to achieve the above object, an obstacle map generation method using an ultrasonic sensor according to an embodiment of the present invention comprising steps of controlling one ultrasonic sensor of a plurality of ultrasonic sensors to transmit an ultrasonic wave by a sensor controller; receiving reflected waves by the ultrasonic sensors; aligning the reflected waves received by the ultrasonic sensors based on a time delay curve by a signal aligner; summing the aligned signals by a signal summer; determining that an obstacle exists if the summed signal strength exceeds a threshold by an obstacle determiner; and generating an obstacle map based on the determining result by an obstacle map generator.

Also, in order to achieve the above object, another obstacle map generation method using an ultrasonic sensor according to an embodiment of the present invention comprises steps of controlling one ultrasonic sensor of a plurality of ultrasonic sensors to transmit an ultrasonic wave with a preset time difference by a sensor controller; receiving reflected waves by the ultrasonic sensors; aligning the reflected waves received by the ultrasonic sensors based on a time delay curve by a signal aligner; summing the aligned signals by a signal summer; determining that an obstacle exists if signal strength summed by the signal summer exceeds a threshold by an obstacle determiner; and generating an obstacle map based on the determining result by an obstacle map generator.

The present invention as described above has the effects which can decrease the obstacle detection error and then improve the performance of the obstacle detection, by generating an obstacle map organically using at least one ultrasonic sensor.

### BRIEF DESCRIPTION OF THE DRAWINGS

The above and other objects, features and advantages of the present invention will be more apparent from the following detailed description taken in conjunction with the accompanying drawings, in which:

FIG. 1 is a configuration diagram of an embodiment of an obstacle map generation apparatus using an ultrasonic sensor according to an embodiment of the present invention.

FIG. 2 is an exemplary diagram for each time delay curve corresponding to an obstacle detection area according to an embodiment of the present invention.

FIG. 3 is an exemplary diagram for an obstacle map generating process using an ultrasonic sensor according to an embodiment of the present invention.

FIG. 4 is a flowchart of an embodiment for an obstacle map generating method using an ultrasonic sensor according to an embodiment of the present invention.

FIG. 5 is a flowchart of another embodiment for an obstacle map generating method using an ultrasonic sensor according to an embodiment of the present invention.

### DETAILED DESCRIPTION OF THE PREFERRED EMBODIMENTS

Hereinafter, a preferred embodiment of the present invention will be described in detail with reference to the accompanying drawings.

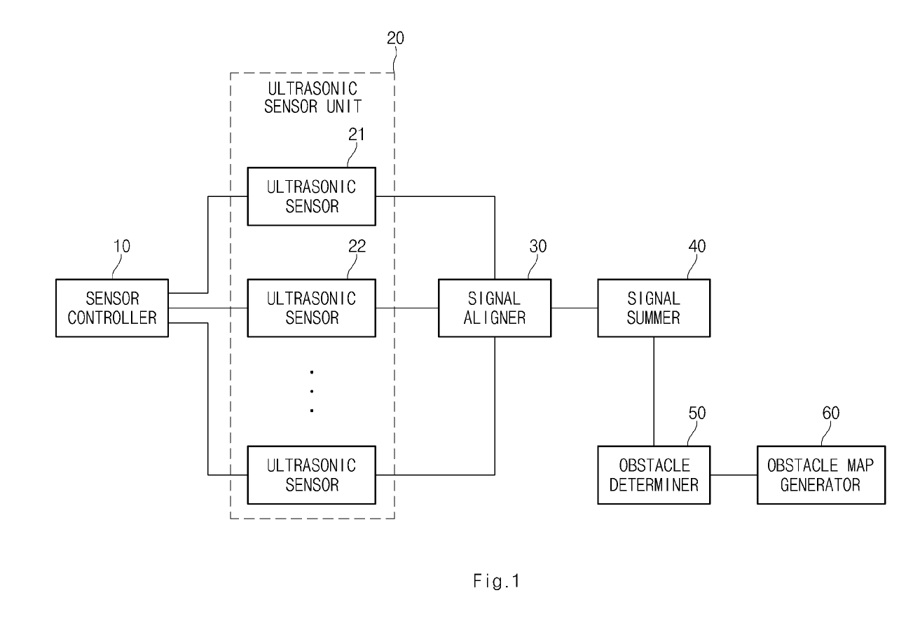

FIG. 1 is a configuration diagram of an embodiment of an obstacle map generation apparatus using an ultrasonic sensor according to an embodiment of the present invention.

As shown in FIG. 1, the obstacle map generation apparatus according to an embodiment of the present invention includes a sensor controller 10, an ultrasonic sensor unit 20, a signal aligner 30, the signal summer 40, the obstacle determiner 50 and an obstacle map generator 60.

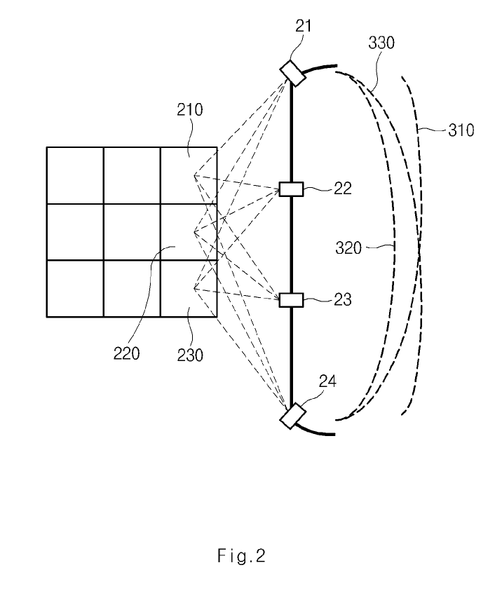

With reference to respective components, first, the sensor controller 10 selects one of a plurality of ultrasonic sensors and causes it to transmit ultrasonic waves, or controls at least one ultrasonic sensor to transmit ultrasonic waves with a preset time difference. At this time, the reception of the reflected wave is performed in all ultrasonic sensors. Hereinafter, with reference to FIG. 2, two types of manners which the sensor controller 10 controls each ultrasonic sensor will be explained respectively.

As a first embodiment, the sensor controller 10 selects the ultrasonic sensor proximately located in the detection area of a plurality of ultrasonic sensors and controls it to transmit ultrasonic waves. The reflected waves of the transmitted ultrasonic waves are received to all ultrasonic sensors.

As shown in FIG. 2, the obstacle map generation apparatus according to an embodiment of the present invention, as an example, comprises a first ultrasonic sensor 21, a second ultrasonic sensor 22, a third ultrasonic sensor 23 and a fourth ultrasonic sensor 24. Here it is assumed that nine obstacle detection areas exist. Also, the number of ultrasonic sensors and the number of obstacle detection areas are changeable according to the intention of the designer and the present invention is not affected at all.

As an example, when detecting whether an obstacle exists or not for the obstacle detection area 210, the sensor controller 10 controls the second ultrasonic sensor 22 closest to the obstacle detection area 210 to transmit ultrasonic waves. At this time, the sensor controller 10 controls all of the first ultrasonic sensor 21, the second ultrasonic sensor 22, the third ultrasonic sensor 23 and the fourth ultrasonic sensor 24 to receive reflected waves.

As another example, when detecting whether an obstacle exists or not for the obstacle detection area 220, the sensor controller 10 controls the second ultrasonic sensor 22 closest to the obstacle detection area 220 to transmit ultrasonic waves. At this time, the sensor controller 10 controls all of the first ultrasonic sensor 21, the second ultrasonic sensor 22, the third ultrasonic sensor 23 and the fourth ultrasonic sensor 24 to receive reflected waves.

As another example, when detecting whether an obstacle exists or not for the obstacle detection area 230, the sensor controller 10 controls the third ultrasonic sensor 23 closest to the obstacle detection area 230 to transmit ultrasonic waves. At this time, the sensor controller 10 controls all of the first ultrasonic sensor 21, the second ultrasonic sensor 22, the third ultrasonic sensor 23 and the fourth ultrasonic sensor 24 to receive reflected waves.

As a second embodiment, the sensor controller 10 stores time difference information. The time difference information can indicate which ultrasonic waves transmitted by the first ultrasonic sensor 21, the second ultrasonic sensor 22, the third ultrasonic sensor 23 and the forth ultrasonic sensor 24 reach a certain obstacle detection area to be identical, for each of the obstacle detection areas. At this time, the time difference information is different for each obstacle detection area.

Accordingly, the sensor controller 10 can control each ultrasonic sensor so that the ultrasonic waves transmitted from each ultrasonic sensor reach a certain obstacle detection area at the same time.

As an example, when detecting whether obstacles exist or not for the obstacle detection area 210, the sensor controller 10 sequentially controls each ultrasonic sensor based on the time difference information. In this way, the ultrasonic waves transmitted from each ultrasonic sensor reach the obstacle detection area 210 at the same time and then the first ultrasonic sensor 21, the second ultrasonic sensor 22, the third ultrasonic sensor 23 and the forth ultrasonic sensor 24 receive the reflected waves. This process is equally applied for all obstacle detection areas.

Next, the ultrasonic sensor unit 20 comprises at least one ultrasonic sensor and each ultrasonic sensor operates under the control of the sensor controller 10. Then, the signal aligner 30 aligns the reflected waves received by each ultrasonic sensor based on time delay curve.

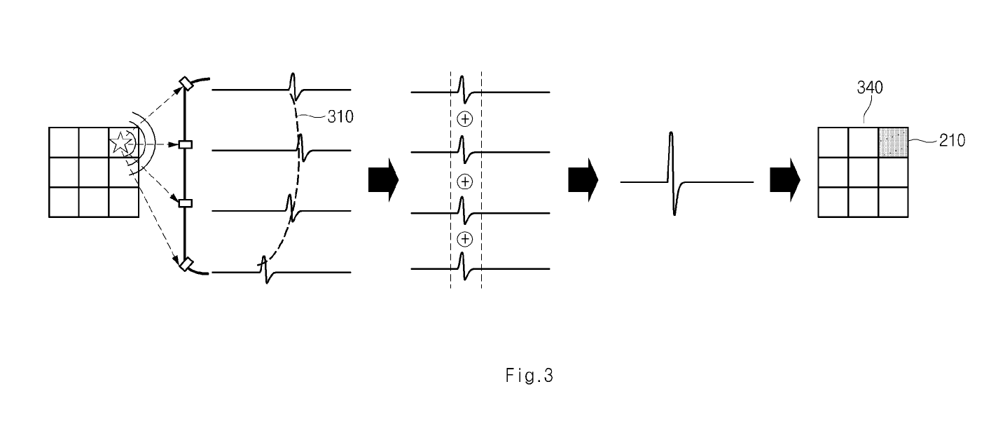

Hereinafter, with reference to FIGS. 2 and 3, the operation for the signal aligner 30 will be described in detail.

FIG. 2 illustrates an example of the time delay curve depending on the distance between each obstacle detection area and each ultrasonic sensor. The time delay curve corresponding to the obstacle detection area 210 is ‘310’, the time delay curve corresponding to the obstacle detection area 220 is ‘320’ and the time delay curve corresponding to the obstacle detection area 230 is ‘330’.

FIG. 3 illustrates an example aligning the reflected waves received by the first ultrasonic sensor 21, the second ultrasonic sensor 22, the third ultrasonic sensor 23 and the fourth ultrasonic sensor 24, based on the time delay curve 310 corresponding to the obstacle detection area 210 according to an embodiment of the present invention.

Next, the signal summer 40 sums the signals aligned by the signal aligner 30. Then, the obstacle determiner 50 determines that an obstacle exists if the signal strength summed by the signal summer 40 exceeds a threshold.

Next, the obstacle map generator 60 generates the obstacle map 340 based on the determining result of the obstacle determiner 50. At this time, the shaded mark of the obstacle detection area 210 in the obstacle map 340 means that an obstacle exists.

In this way, the foregoing process is performed for all obstacle detection areas and the obstacle map 340 is completed.

The generated obstacle map 340 may be used in various in-vehicle controllers (PAS, SPAS, AVM, etc.) usefully.

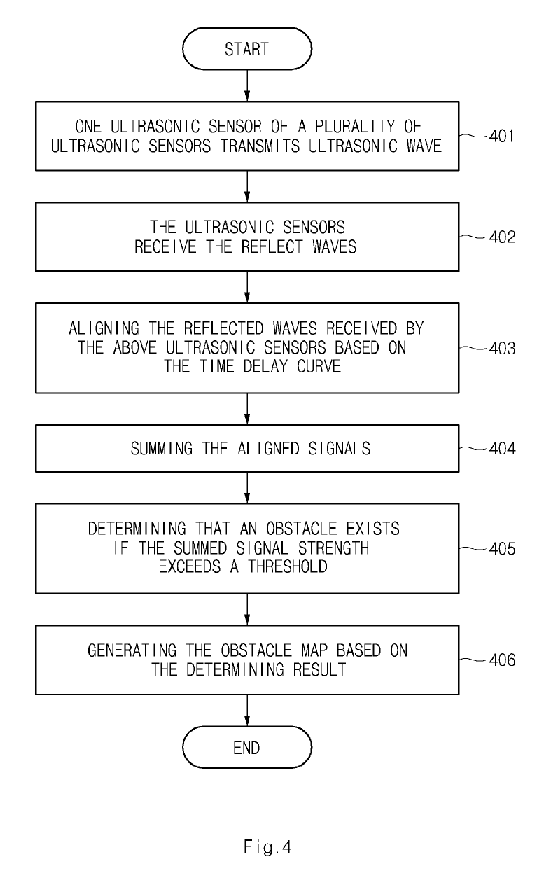

FIG. 4 is a flowchart of an embodiment for an obstacle map generating method using an ultrasonic sensor according to an embodiment of the present invention.

First, the sensor controller 10 controls one ultrasonic sensor of a plurality of ultrasonic sensors to transmit an ultrasonic wave (401). Then, the above ultrasonic sensors receive the reflected waves (402). The signal aligner 30 then aligns the reflected waves received by the above ultrasonic sensors based on the time delay curve (403). The signal summer 40 then sums the signals aligned by the signal aligner 30 (404). The obstacle determiner 50 then determines that an obstacle exists if the signal strength summed by the signal summer 40 exceeds a threshold (405). The obstacle map generator 60 then generates the obstacle map based on the determining result of the obstacle determiner 50 (406).

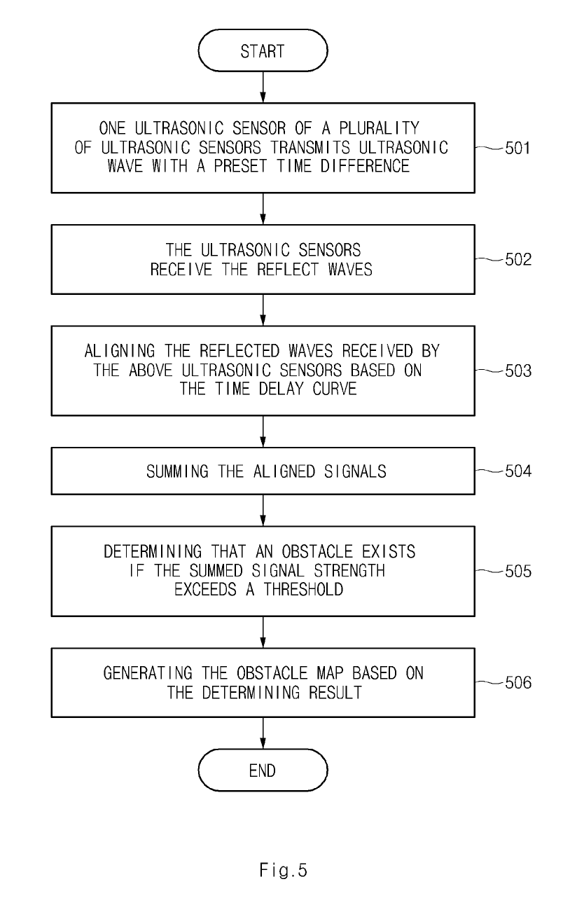

FIG. 5 is a flowchart of another embodiment for an obstacle map generating method using an ultrasonic sensor according to an embodiment of the present invention.

First, the sensor controller 10 controls a plurality of ultrasonic sensors to transmit an ultrasonic wave with a preset time difference (501). Then, the above ultrasonic sensors receive the reflected waves (502). Then, the signal aligner 30 aligns the reflected waves received by the above ultrasonic sensors based on the time delay curve (503).

The signal summer 40 then sums the signals aligned by the signal aligner 30 (504). Then, the obstacle determiner 50 determines that an obstacle exists if the signal strength summed by the signal summer 40 exceeds a threshold (505). The obstacle map generator 60 then generates the obstacle map based on the determining result of the obstacle determiner 50 (506).

What is claimed is:

1. An obstacle map generation apparatus using an ultrasonic sensor comprising:
a sensor controller configured to control one ultrasonic sensor of a plurality of ultrasonic sensors to transmit an ultrasonic wave, and control the ultrasonic sensors to receive reflected waves;
a signal aligner configured to align the reflected waves received by the ultrasonic sensors;
a signal summer configured to sum signals aligned by the signal aligner;
an obstacle determiner configured to determine that an obstacle exists if signal strength summed by the signal summer exceeds a threshold; and
an obstacle map generator configured to generate an obstacle map based on determining result of the obstacle determiner.

2. The obstacle map generation apparatus using an ultrasonic sensor according to claim 1, wherein the sensor controller controls the ultrasonic sensor closest to an obstacle detection area of the ultrasonic sensors to transmit the ultrasonic wave.

3. The obstacle map generation apparatus using an ultrasonic sensor according to claim 2, wherein the signal aligner comprises a time delay curve corresponding to each obstacle detection area.

4. The obstacle map generation apparatus using an ultrasonic sensor according to claim 3, wherein the obstacle map generator generates an obstacle map which displays whether an obstacle exists or not for each obstacle detection area.

5. An obstacle map generation apparatus using an ultrasonic sensor comprising:
a sensor controller configured to control one ultrasonic sensor of a plurality of ultrasonic sensors to transmit an ultrasonic wave with a preset time difference, and control the ultrasonic sensors to receive reflected waves;
a signal aligner configured to align the reflected waves received by the ultrasonic sensors;
a signal summer configured to sum signals aligned by the signal aligner;
an obstacle determiner configured to determine that an obstacle exists if signal strength summed by the signal summer exceeds a threshold; and
an obstacle map generator configured to generate an obstacle map based on determining result of the obstacle determiner.

6. The obstacle map generation apparatus using an ultrasonic sensor according to claim 5, wherein the time difference causes the time each ultrasonic wave transmitted by the ultrasonic sensors reaches a certain obstacle detection area to be identical.

7. The obstacle map generation apparatus using an ultrasonic sensor according to claim 6, wherein the time difference is different for each obstacle detection area.

8. The obstacle map generation apparatus using an ultrasonic sensor according to claim 5, wherein the signal aligner comprises a time delay curve corresponding to each obstacle detection area.

9. The obstacle map generation apparatus using an ultrasonic sensor according to claim 5, wherein the obstacle map generator generates an obstacle map which displays whether an obstacle exists or not for each obstacle detection area.

10. An obstacle map generation method using an ultrasonic sensor comprising steps of:
controlling one ultrasonic sensor of a plurality of ultrasonic sensors to transmit an ultrasonic wave by a sensor controller;
receiving reflected waves by the ultrasonic sensors;
aligning the reflected waves received by the ultrasonic sensors based on a time delay curve by a signal aligner;
summing the aligned signals by a signal summer;
determining that an obstacle exists if the summed signal strength exceeds a threshold by an obstacle determiner; and
generating an obstacle map based on the determining result by an obstacle map generator.

11. The obstacle map generation method using an ultrasonic sensor according to claim 10, wherein the sensor controlling step controls the ultrasonic sensor closest to an obstacle detection area of the ultrasonic sensors to transmit the ultrasonic wave.

12. The obstacle map generation method using an ultrasonic sensor according to claim 11, wherein the signal aligning step aligns the reflected waves based on a time delay curve corresponding to each obstacle detection area.

13. The obstacle map generation method using an ultrasonic sensor according to claim 12, wherein the obstacle map generating step generates an obstacle map which displays whether an obstacle exists or not for each obstacle detection area.

14. An obstacle map generation method using an ultrasonic sensor comprising steps of:
controlling one ultrasonic sensor of a plurality of ultrasonic sensors to transmit an ultrasonic wave with a preset time difference by a sensor controller;
receiving reflected waves by the ultrasonic sensors;
aligning the reflected waves received by the ultrasonic sensors based on a time delay curve by a signal aligner;
summing the aligned signals by a signal summer;
determining that an obstacle exists if signal strength summed by the signal summer exceeds a threshold by an obstacle determiner; and
generating an obstacle map based on the determining result by an obstacle map generator.

15. The obstacle map generation method using an ultrasonic sensor according to claim 14, wherein the time difference causes the time each ultrasonic wave transmitted by the ultrasonic sensors reaches a certain obstacle detection area to be identical.

16. The obstacle map generation method using an ultrasonic sensor according to claim 15, wherein the time difference is different for each obstacle detection area.

17. The obstacle map generation method using an ultrasonic sensor according to claim 14, wherein the signal aligning step aligns the reflected waves based on a time delay curve corresponding to each obstacle detection area.

18. The obstacle map generation method using an ultrasonic sensor according to claim 17, wherein the obstacle map generating step generates an obstacle map which displays whether an obstacle exists or not for each obstacle detection area.
